(19) United States
(12) Patent Application Publication
(10) Pub. No.: US 2021/0164445 A1
(43) Pub. Date: Jun. 3, 2021

(54) Wind Power Generation Apparatus

(71) Applicant: K.Y. Lin, Tainan City (TW)

(72) Inventor: K.Y. Lin, Tainan City (TW)

(21) Appl. No.: 17/080,967

(22) Filed: Oct. 27, 2020

(30) Foreign Application Priority Data
Dec. 3, 2019 (TW) 108144099
Dec. 3, 2019 (TW) 108216078

(51) Int. Cl. F03D 9/25; F03D 13/20

(52) U.S. Cl. CPC F03D 9/25; F03D 3/005; F03D 13/20

(57) ABSTRACT

A wind power generation apparatus mainly disposes a support axle inside a tower rack of a wind power generator, and an upper vertical axle blade and a lower vertical axle blade arranged upwardly and downwardly are at least pivotally jointed on the support axle disposed inside the tower rack. A windward opening is disposed at the position where a circumference wall of the tower rack corresponds to the upper and lower vertical axle blades, and the lateral wind could enter into the tower rack through the windward opening to cause tornado effect to push the upper and lower vertical axle blades to rotate and output dynamic force to connect the power generator and generate electricity.

### BACKGROUND OF THE INVENTION

### Field of the Invention

The present invention relates to a wind power generation apparatus, and more particularly to the apparatus capable of benefiting output power and cost effectiveness as Cost-Performance (CP) ratio of wind power generation.

### Description of the Related Art

A wind power generator can be approximately classified into two types of a vertical axle wind power generator 5 (as shown in FIG. 1) and a horizontal axle wind power generator 6 (as shown in FIG. 2) according to direction of a rotation axle. The structure of the wind power generator mainly comprises three portions of a tower rack, blades, and a power generator, wherein space and structure function of the tower rack merely support one kind of blades and the power generator without developing other purposes.

The inventor(s) thinks that space, structure and configuration occupied by the tower rack may have other functions to sufficiently benefit generation power output.

### SUMMARY OF THE INVENTION

The inventor(s) considers the problem needs improvement and therefore, the inventor(s) carries out deep researches to finally create the innovate design upon long term effort.

The primary objective of the present invention is to change structural design, space and utilization of pneumatic function in a tower rack, and design in blades and power generator, configuration and system combination to increase generation power output and cost benefits of a wind power generator.

A primary characteristic of the invention is that a support axle is disposed inside the tower rack of the wind power generator. An upper vertical axle blade and a lower vertical axle blade arranged upwardly and downwardly are at least pivotally jointed on the support axle disposed inside the tower rack. A windward opening is disposed at the position where a circumference wall of the tower rack corresponds to the upper and lower vertical axle blades. Lateral wind can enter into the tower rack through the windward openings to push the upper and lower vertical axle blades to rotate. Rotation directions of the upper and lower vertical axle blades are configured to form reverse rotation so that rotation torques of the upper and lower vertical axle blades can achieve mutual balance. Moreover, the upper and lower vertical axle blades can be connected to a power generator unit to generate electricity through power outputted by rotation. With the disposition, more blades and power generators can be added in addition to a wind force blade and a power generator originally supported by the tower rack in conventional technique, and aerodynamic force design inside the tower rack is utilized to benefit the whole power generation effect.

The technical characteristics, contents, advantages and effects of the present invention will be apparent with the detailed description accompanied with related drawings of two preferred embodiments as follows.

### BRIEF DESCRIPTION OF THE DRAWINGS

FIG. 1 is an appearance of a conventional vertical axle wind power generator;

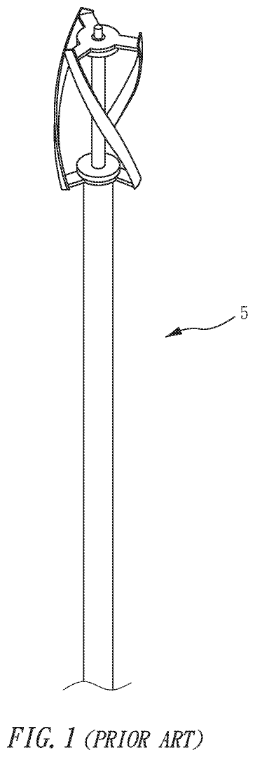

FIG. 2 is an appearance of a conventional horizontal axle wind power generator;

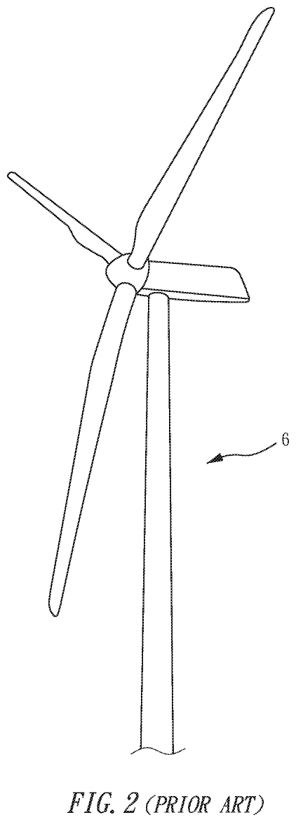

FIG. 3 is a structural stereogram (over-length portion of tower rack portion is displayed with dotted line) of an embodiment of the invention applied to the vertical axle wind power generator;

FIG. 4 is a partial enlarged drawing according to FIG. 3;

FIG. 5 is a structural cross-sectional drawing of an embodiment of the invention applied to the vertical axle wind power generator;

FIG. 6 is a partial enlarged drawing according to FIG. 5;

FIG. 7 is a 7s-7s cross-sectional drawing according to FIG. 6;

FIG. 8 is a top view according to FIG. 6;

FIG. 9 is a structural stereogram of an embodiment of the invention applied to a horizontal axle wind power generator;

FIG. 10 is a structural drawing of using a cross-over pipe to connect between tower racks of the vertical axle wind power generator and the horizontal axle wind power generator according to an embodiment of the invention;

FIG. 11 is a structural drawing of using cross-over pipes to connect among tower racks of multiple vertical axle wind power generators and one horizontal axle wind power generator according to an embodiment of the invention;

FIG. 12 is another structural drawing of induction stator magnetic field according to an embodiment of the invention; and

FIG. 13 is a hollow tubular structural drawing of a support axle according to an embodiment of the invention.

### DETAILED DESCRIPTION OF THE PREFERRED EMBODIMENTS

The technical characteristics, contents, advantages and effects of the present invention will be apparent with the detailed description accompanied with related drawings of preferred embodiments as follows.

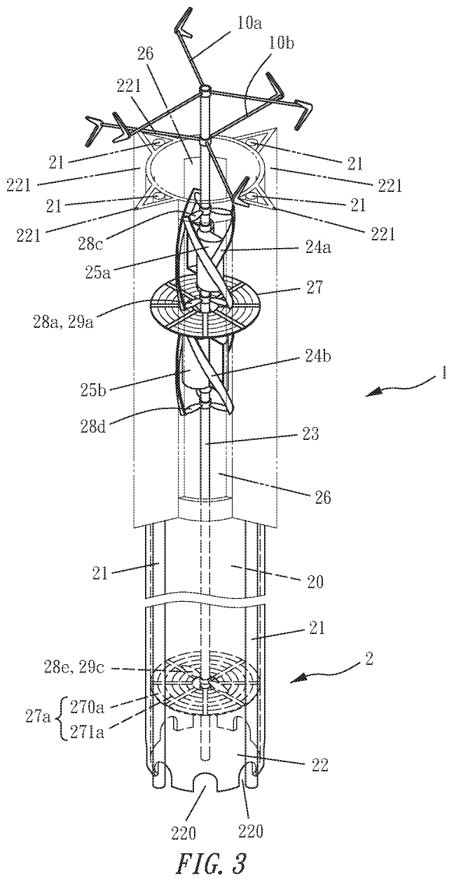

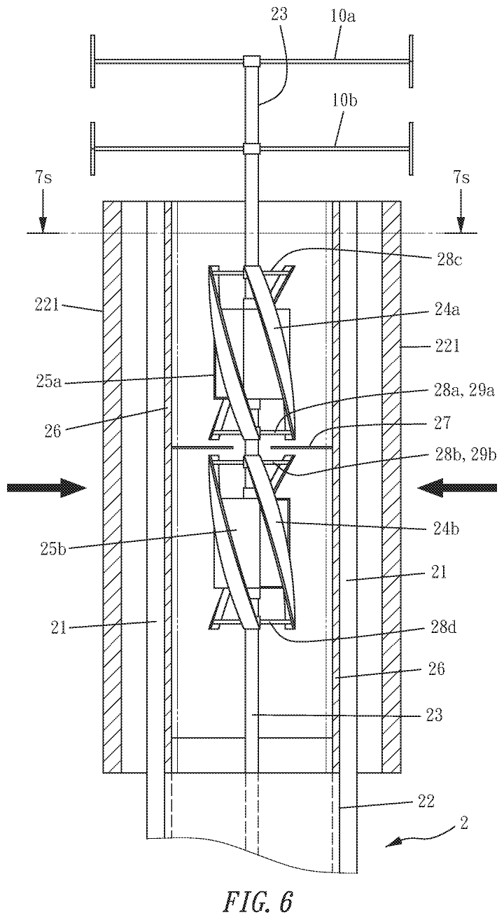

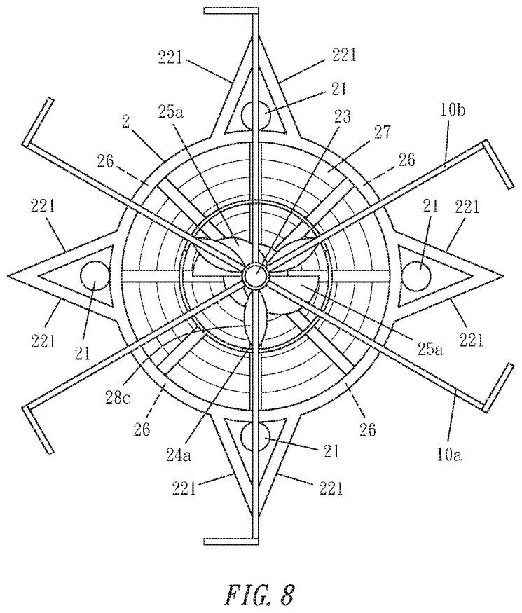

With reference to FIGS. 3-8, structural drawings of an embodiment of the invention applied to a vertical axle wind power generator 1 are shown. The vertical axle wind power generator 1 comprises a tower rack 2 that is a hollow shape; an upper and lower sets of rotation blades 10a, 10b supported above a top end of the tower rack 2, wherein the two rotation blades 10a, 10b can be rotated and driven by natural wind force and connected to a power generator (a conventional technique is not shown in the figure) to generate electricity.

The primary improvement of the invention is that: the tower rack 2 is hollow column shape and has an empty space 20 therein. An external circumference side of the tower rack 2 is surrounded with a plurality of vertical posts 21. A side wall of the vertical post 21 is connected to a circumference wall 22 of the tower rack 2 to enhance the structural strength of the tower rack 2. Moreover, costs are decreased by reducing requirement of sheet material property of the circumference wall 22 composing the tower rack 2. An immobile support axle 23 is disposed inside the empty space 20. A top end of the support axle 23 stretches out of a top end opening of the tower rack 2 to pivot the rotation blades 10a, 10b. A circumference wall 22 at a bottom end of the tower rack 2 is configured with several downwind openings 220 capable of being sealed or opened to increase aerodynamic energy inside the tower rack 2. Moreover, the circumference wall 22 of the bottom end of the tower rack 2 has light transmittance to heat up air within the tower rack 2. Accordingly, thermal air below the tower rack 2, through principle of upward heat transport, enters into the tower rack 2 via the downwind opening 220 so that thermal air upwardly moves through chimney effect. Alternatively, air within the tower rack 2 downwardly moves through dynamic power driving to be delivered to another tower rack 2 via the downwind opening 220.

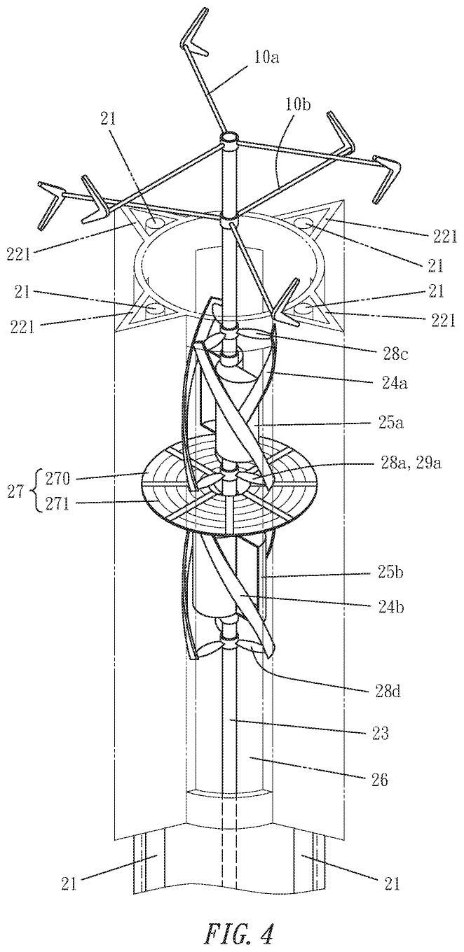

At least two upper vertical axle blade 24a and lower vertical axle blade 24b (FIGS. 3, 4) upwardly and downwardly arranged are located at the support axle 23 on the top end inside the tower rack 2. Half barrel auxiliary blades 25a, 25b homologously linked to the vertical axle blades 24a, 24b are configured inside the upper and lower vertical axle blades 24a, 24b. The half barrel auxiliary blades 25a, 25b can take much lateral wind to support initiating rotation of the upper and lower vertical axle blades 24a, 24b and guide airstream. The rotation directions of the upper and lower vertical axle blades 24a, 24b are configured as opposite direction so that both rotation torques balance. Furthermore, the rotation dynamic power of the upper and lower vertical axle blades 24a, 24b can be respectively connected to a power generator to individually generate power through gear mechanism. To increase the rotation speed of the upper and lower vertical axle blades 24a, 24b, blade shape of the upper and lower vertical axle blades 24a, 24b can, via chimney effect, also be designed to have effect of rotation pushed by upwardly moved wind force in the tower rack 2.

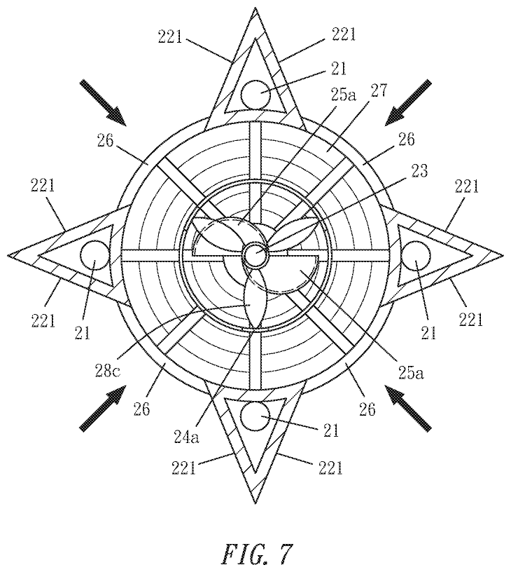

The circumference wall 22 of the tower rack 2 corresponding to the upper and lower vertical axle blades 24a, 24b is opened with windward openings 26 (as shown in FIG. 7, at least one windward opening is provided, and a plurality of windward openings is shown in the embodiment). Wind naturally flowing outside the tower rack 2 can enter into the tower rack 2 via the windward openings 26 to push the upper and lower vertical axle blades 24a, 24b and the two auxiliary blades 26a, 25b to rotate. To increase air volume, two sides of the circumference wall 22 corresponding to the windward openings 26 are configured with wind boards 221 obliquely stretching toward outside of the tower rack 2 as shown in FIG. 7.

An induction stator magnetic field 27, between the upper and lower vertical axle blades 24a, 24b that are upwardly and downwardly adjoined, is horizontally and fixedly disposed inside the tower rack 2. The induction stator magnetic field 27 is composed of comprising a grid hole-like metal plate 270 and an excitation coil 271 (as shown in FIG. 4). The metal plate 270 is supported by the internal wall of the tower rack 2 to position. Axle flow blades 28a, 28b rotating in accordance with the upper and lower vertical axle blades 24a, 24b are respectively configured at end surfaces of the upper and lower vertical axle blades 24a, 24b facing the induction stator magnetic field 27 (when the axle flow blades 28a, 28b rotate, wind flow direction inside an empty space 20 of the tower rack 2 can be driven to become axle flow). The two axle flow blades 28a, 28b rotate in accordance with attached vertical axle blades 24a, 24b. Although rotation directions of the two axle flow blades 28a, 28b are opposite, the design of blade angle can be consistent with a direction of pushing wind force (for example, wind direction is consistently upward). The two axle flow blades 28a, 28b are processed by magnetization to form rotor magnetic fields 29a, 29b. Between the induction stator magnetic field 27 and the two rotor magnetic fields 29a, 29b, the rotor magnetic fields 29a, 29b are mutually induced with the induction stator magnetic field 27 through rotation of the rotor magnetic fields 29a, 29b to divide magnetic force so as to further generate power. The foregoing power generation function increases power generation efficiency through opposite rotation directions of the two rotor magnetic fields 29a, 29b. Moreover, an upper axle flow blade 28c homologously linked to the upper vertical axle blade 24a is configured at the top end of the upper vertical axle blade 24a. A lower axle flow blade 28d homologously linked to the lower vertical axle blade 24b is configured at a bottom end of the lower vertical axle blade 24b. Disposition of the upper axle flow blade 28c and the lower axle flow blade 28d can increase pushing of axial wind inside the tower rack 2.

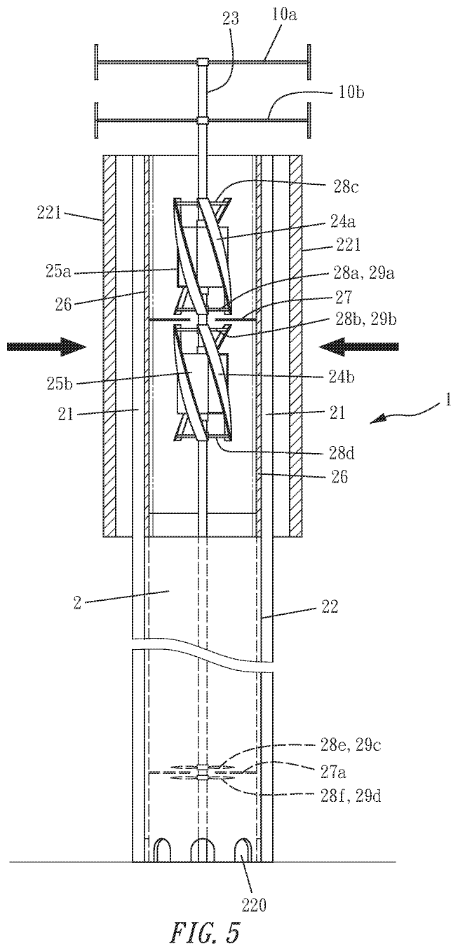

Two auxiliary axle flow blades 28e, 28f (as shown in FIGS. 3, 5) respectively arranged in upper and lower directions are pivoted below the support axle 12 inside the empty space 220. The two auxiliary axle flow blades 28e, 28f are similar to the two axle flow blades 28a, 28b. Blade angles of the two auxiliary axle flow blades 28e, 28f are designed to reverse rotation directions while receiving axial wind so that both rotation torques balance, and both wind directions are in the same direction. Moreover, blades are processed by magnetization to compose rotor magnetic fields 29c, 29d. A second induction stator magnetic field 27a is configured between the two auxiliary axle flow blades 28e, 28f. The second induction stator magnetic field 27a, which is similar to the induction stator magnetic field 27, is composed of a grid hole-like metal plate 270a and an excitation coil 271a winding the metal plate 270a. It is mutually induced with the second induction stator magnetic field 27a through rotation of the rotor magnetic fields 29c, 29d to divide magnetic force so as to further generate power. With opposite rotation directions of the rotor magnetic fields 29c, 29d, the power generation efficiency mutually induced with the second induction stator magnetic field 27a can be increased. With rotation of the two auxiliary axle flow blades 28e, 28f, flowing speed of axially flowing wind entering into the tower rack 2 from the downwind opening 220 can be supported as the same as small tornado effect. The rotation directions of the two auxiliary axle flow blades 28e, 28f are designed as opposite direction to benefit mutual induction between the rotor magnetic fields 29c, 29d and the second induction stator magnetic field 27a and magnetic force dividing, thereby increasing power generation effect. Further, although the rotation directions of the two auxiliary axle flow blades 28e, 28f are opposite, a function of being consistent with pushed wind direction is achieved through design of blade shape. The foregoing pushed wind direction is the same as wind directions pushed by the axle flow blades 28a, 28b through restriction so that the axle flow blades 28a, 28b and the two auxiliary axle flow blades 28e, 28f have effect of continuously pushing axle wind flow inside the tower rack 2. Secondary, no second induction stator magnetic field 27a can be disposed between the two auxiliary axle flow blades 28e, 28f. The rotation dynamic energy of the two auxiliary axle flow blades 28e, 28f can be respectively acted by the gear mechanism to drive a power generator for generating power, thereby benefiting power generation effect.

When the embodiment of the invention is applied to a vertical axle wind power generator 1 as shown in FIGS. 3, 5, not only rotation dynamic power generated from the rotation blades 10a, 10b, which are pushed by natural wind force, exposed above the tower rack 2 generates power by connecting the power generator but also rotation dynamic power of the upper and lower vertical axle blades 24a, 24b configured inside the empty space 20 of the tower rack 2 can generate power by linking a respective connected power generator. The axle flow blades 28a, 28b are processed by magnetization to form rotor magnetic fields 29a, 29b to mutually induce with the induction stator magnetic field 27 so as to divide magnetic force, thereby generating power as well. The auxiliary axle flow blades 28e, 28f are processed by magnetization to form rotor magnetic fields 29c, 29d to mutually induce with the second induction stator magnetic filed 27a so as to divide magnetic force, thereby generating power as well. Accordingly, the invention has effect of benefiting power generation capacity. Furthermore, a plurality of downwind openings 220 is configured to a circumference wall 22 at the bottom end of the tower rack 2 according to the invention so that thermal air below the tower rack 2 enters into the tower rack 2 via the downwind opening 220. With principle of chimney effect, axial wind inside the tower rack 2 is pushed by the auxiliary axle flow blades 28e, 28f, the lower axle flow blade 28d, the two axle flow blades 28a, 28b, and the upper axle flow blade 28c from the bottom to the top to compose small tornado effect. Axle directional wind force is extremely powerful to increase axial wind speed inside the tower rack 2, thereby increasing better power generation effect.

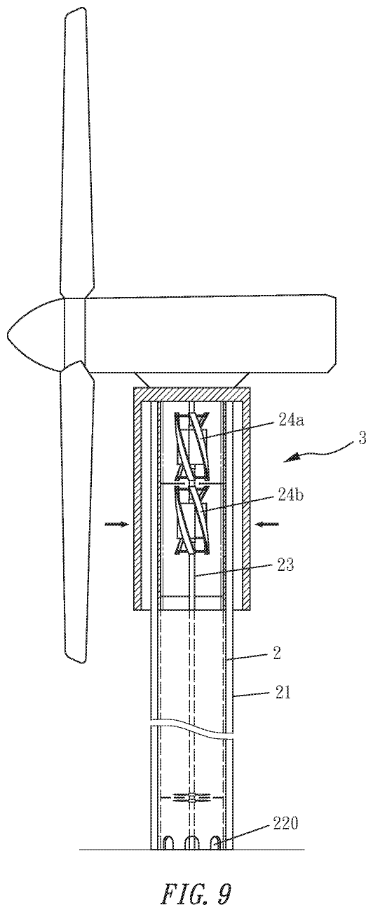

Next, with reference to FIG. 9, a structural drawing of an embodiment according to the invention is applied to a horizontal axle wind power generator 3. The structure of the tower rack 2 and mechanism configuration inside the tower rack 2 are the same as shown in FIGS. 3, 5.

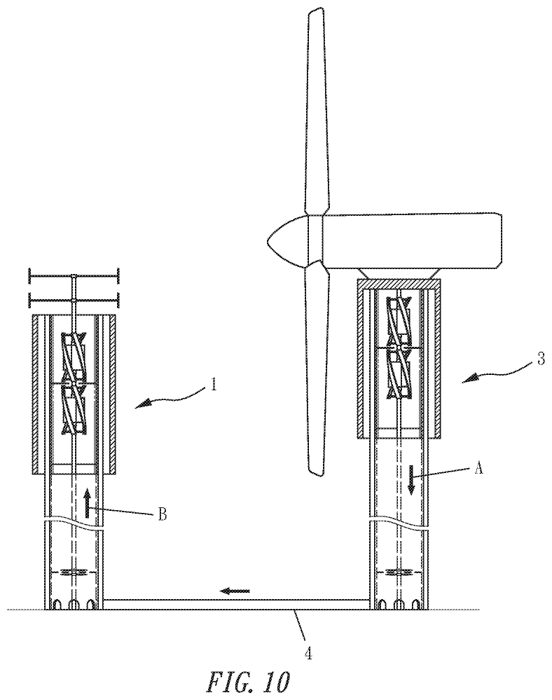

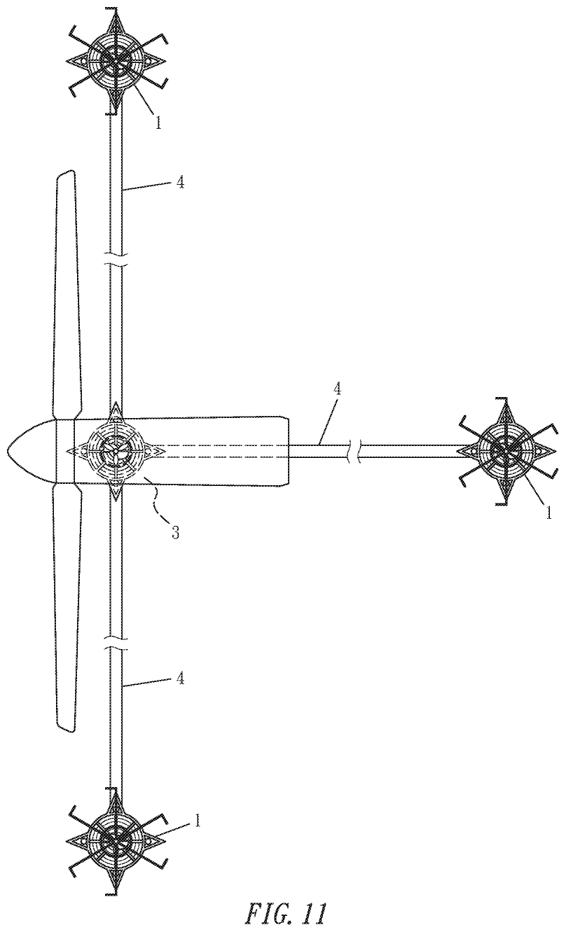

With reference to FIG. 10, a cross-over pipe 4 having light transmittance communicates the downwind openings 220 at the bottom ends of the tower racks 2 of the vertical axle wind power generator 1 and the horizontal axle wind power generator 3, and axial wind direction inside the tower rack 2 can be designed. For example, axial wind direction inside the tower rack of the horizontal axle wind power generator 3 is downwind (as shown in arrow A) while axial wind direction inside the tower rack of the vertical axle wind power generator 1 is upward (as shown in arrow B). Axial wind inside the tower rack 2 of the horizontal axle wind power generator 3 flows into the tower rack of the vertical axle wind power generator 1 according to Bernoulli's law after heating up through outer heat of the cross-over pipe 4 having light transmittance so that air quantity inside the tower rack of the vertical axle wind power generator 1 can be further benefited. With chimney effect, air flow taking and rotational speed of the vertical axle blades 24a, 24b, the axle flow blades 28a, 28b, and the auxiliary axle flow blades 28e, 28f inside the tower rack 2 can be increased to have better power generation effect. As shown in FIG. 11, the downwind openings 220 among a horizontal axle wind power generator 3 and a plurality of vertical axle wind power generators 1 are communicated with the cross-over pipes 4. Moreover, the downwind openings 220 of a plurality of vertical axle wind power generators 1 and a plurality of horizontal axle wind power generators 3 are communicated with the cross-over pipes 4. Accordingly, wind inside different tower racks 2 can be introduced into adjacent tower racks 2 through forward setting of wind direction so as to benefit wind power generation effect.

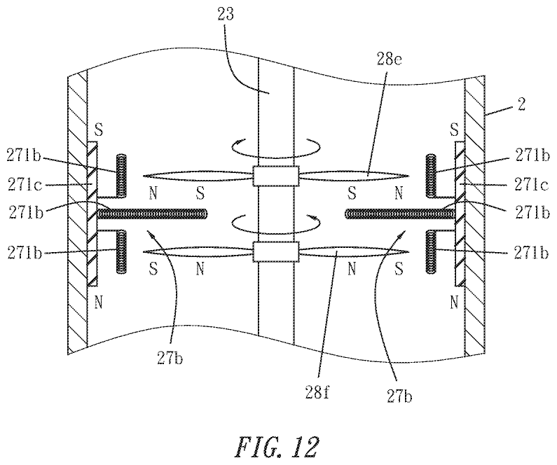

Afterward the structures of the two auxiliary axle flow blades 28e, 28f and the second induction stator magnetic field 27a disclosed in FIG. 5 can be shown in FIG. 12, wherein rotation directions of the two auxiliary axle flow blades 28e, 28f are opposite and are magnetized to have S, N poles. The structure of the second induction stator magnetic field 27a is shown in FIG. 12. A disposition position of an internal wall of the tower rack 2 relative to the two auxiliary axle flow blades 28e, 28f is attached with a circle of permanent magnet 271c. A set of horizontal excitation coils 271b is levelly extended from an intermediate of the permanent magnet 271c and between the two auxiliary axle flow blades 28e, 28f. Vertical excitation coils 271b are respectively extended from the permanent magnet 271c and at upper and lower directions of the set of horizontal excitation coils 271b. The two vertical excitation coils 271b are respectively located at neighbor sides of the two auxiliary axle flow blades 28e, 28f. When the magnetized two auxiliary axle flow blades 28e, 28f rotate, both blades generate relative link together with the excitation coils 271b. Since line of magnetic force is divided to generate power and rotation directions of the two auxiliary axle flow blades 28e, 28f are opposite, power generation capacity can be increased.

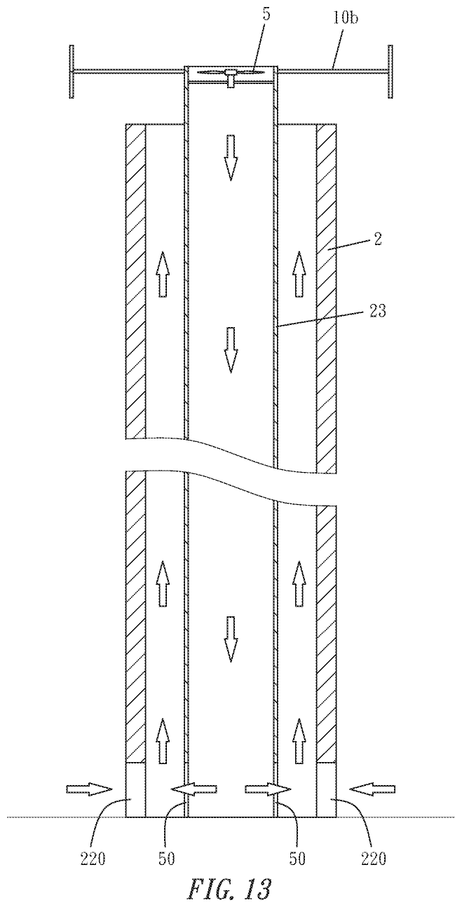

Further, filtration substance capable of absorbing carbon dioxide can be placed inside the tower rack 20. The filtration substance, sodium bicarbonate or potassium bicarbonate for example, absorbs carbon capture within air or exhaust. When air or exhaust is extracted into an internal space of the tower rack 20, it is exhausted after filtering with the filtration substance, capable of reducing carbon dioxide content within air and exhausted by humans. Moreover, power generated by wind force can electrolyze sea water to produce sodium hydroxide, hydrogen and chlorine. The former can reduce carbon, hydrogen can be applied in fuel cell, and chlorine can be manufactured as industrial material to improve application. As shown in FIG. 13, the support axle 23 can also be disposed as tubular shape to form an inner tube and an outer tube of the tower rack 2 (elements, such as the upper axle flow blade 28c, the induction and second induction stator magnetic fields 27, 27a, the upper vertical axle blade 24a and the lower vertical axle blade 24b, are omitted without showing). An axle flow fan 5 is disposed inside a top end of the support axle 23. Several air outlets 50 communicating with inside of the tower rack 2 are disposed at an outer wall of the bottom end so that the axle flow fan 5 can bring cold air above the support axle 23 into the support axle 23. Afterward cold air moves down via the inside of the support axle 23 and then flows out of the air outlet 50 and enters between the tower rack 2 and the support axle 23, thereby increasing wind energy upwardly flowing from the bottom end of the tower rack 2.

While the present invention has been described by means of specific embodiments, numerous modifications and variations could be made thereto by those skilled in the art without departing from the scope and spirit of the invention set forth in the claims.

What is claimed is:

1. A wind power generation apparatus comprising a hollow tower rack and rotation blades fixed above outside of the tower rack; characterized in that a support axle disposed inside the tower rack, at least an upper vertical axle blade and a lower vertical axle blade, which are upwardly and downwardly arranged, pivoted to the support axle; rotation directions of the upper vertical axle blade and the lower vertical axle blade configured to form reversed rotation; an induction stator magnetic field fixed inside the tower rack between the upper vertical axle blade and the lower vertical axle blade, an axle flow blade, which rotates in accordance with the upper vertical axle blade and the lower vertical axle blade, respectively configured at end surfaces adjoined to the upper vertical axle blade and the lower vertical axle blade, the axle flow blade being magnetized to form a rotor magnetic field, the induction stator magnetic field mutually induced with the rotor magnetic field to divide magnetic force so as to generate power; a circumference wall of the tower rack corresponding to the upper vertical axle blade and the lower vertical axle blade opened with a windward opening, lateral wind outside the tower rack entering into the tower rack from the windward opening to push the upper vertical axle blade and the lower vertical axle blade for rotating, dynamic power of the uppert vertical axle blade and the lower vertical axle blade connected to a power generator to generate power.

2. The wind power generation apparatus of claim 1, wherein a top end of the upper vertical axle blade is configured with an upper axle flow blade homologously linked with the upper vertical axle blade; and a bottom end of the lower vertical axle blade is configured with a lower axle flow blade homologously linked with the lower vertical axle blade; and axial wind directions pushed by the upper axle flow blade and the lower axle flow blade in the tower rack are consistent.

3. The wind power generation apparatus of claim 1, wherein two sides of the circumference wall of the tower rack corresponding to the windward opening are configured with wind boards obliquely stretching toward outside of the tower rack.

4. The wind power generation apparatus of claim 1, wherein a circumference wall at a bottom end of the tower rack is configured with a downwind opening, and the downwind opening is opened or closed upon demand.

5. The wind power generation apparatus of claim 4, wherein the support axle inside the tower rack is pivoted with two auxiliary axle flow blades upwardly and downwardly arranged, and rotation directions of the two auxiliary axle flow blades are opposite but directions of pushing axial wind are consistent; and rotation dynamic powers of the two auxiliary axle flow blades respectively drive a power generator for generating power through a gear mechanism.

6. The wind power generation apparatus of claim 4, wherein the support axle inside the tower rack is pivoted with two auxiliary axle flow blades upwardly and downwardly arranged, and rotation directions of the two auxiliary axle flow blades are opposite but directions of pushing axial wind are consistent; and surfaces of the two auxiliary axle flow blades are processed by magnetization to form a rotor magnetic field; and a second induction stator magnetic field is configured between the two auxiliary axle flow blades, and with rotation of the rotor magnetic field, the second induction stator magnetic field is mutually induced to divide magnetic force so as to generate power.

7. The wind power generation apparatus of claim 1, wherein an external circumference side of the tower rack is surrounded with a plurality of vertical posts, and a side wall of the vertical post is connected to the circumference wall of the tower rack.

8. The wind power generation apparatus of claim 1, wherein the induction stator magnetic field is composed of a grid hole-like metal plate and an excitation coil winding the metal plate.

9. The wind power generation apparatus of claim 6, wherein the second induction stator magnetic field is composed of a grid hole-like metal plate and an excitation coil winding the metal plate.

10. The wind power generation apparatus of claim 6, wherein the second induction stator magnetic field is that a disposition positon of an internal wall of the tower rack relative to the two auxiliary axle flow blades is attached with a circle of permanent magnet, and a set of horizontal excitation coils is levelly extended from an intermediate of the permanent magnet and between the two auxiliary axle flow blades, and vertical excitation coils are respectively extended from the permanent magnet and at upper and lower directions of the set of horizontal excitation coils, and the two vertical excitation coils are respectively located at neighbor sides of the two auxiliary axle flow blades.

11. The wind power generation apparatus of claim 1, wherein a linked half barrel auxiliary blade is configured inside the upper vertical axle blade and the lower vertical axle blade, and, via the windward opening, lateral wind entering into the tower rack from outside of the tower rack is taken by the half barrel auxiliary blade.

12. The wind power generation apparatus of claim 4, wherein the downwind opening, upon demand, communicates with an inside at a bottom end of the tower rack of another wind power generator through a cross-over pipe having light transmittance.

13. The wind power generation apparatus of claim 4, wherein a filtration substance capable of absorbing carbon dioxide is placed inside the tower rack.

14. The wind power generation apparatus of claim 4, wherein the support axle is a tubular shape to form an inner tube and an outer tube of the tower rack; and an axle flow fan is disposed inside a top end of the support axle while an outer wall at a bottom end is disposed with several air outlets communicating with the inside of the tower rack.
